(19) United States
(12) Patent Application Publication
(10) Pub. No.: US 2025/0269778 A1
(43) Pub. Date: Aug. 28, 2025

(54) VIBRATING WARNING SYSTEM FOR SIGNALING DIRECTION INDICATORS

(71) Applicant: Vincenzo MARESCA, Terracina (Latina) (IT)

(72) Inventor: Vincenzo MARESCA, Terracina (Latina) (IT)

(21) Appl. No.: 19/204,993

(22) Filed: May 12, 2025

Related U.S. Application Data
(63) Continuation of application No. 18/284,521, filed on Sep. 27, 2023, now Pat. No. 12,319,185.

(30) Foreign Application Priority Data
Apr. 2, 2021 (IT) 102021000008390

(51) Int. Cl. B60N 2/90; B60N 2/00; B60Q 9/00

(52) U.S. Cl. CPC B60N 2/90; B60N 2/002; B60N 2/0034; B60N 2/976; B60Q 9/00; B60N 2002/981; B60N 2210/40

(57) ABSTRACT

A device (e.g., a car seat cover) provided with a vibrating warning system for signaling a condition of direction indicators has a seat cover, a support base, a plurality of flat bases on right and left sides of the support base, each one provided with at least one vibrating motor, and an electronic control unit provided with a connector for connecting the electronic control unit to a car control unit, and configured to receive by the car control unit a signal relating to the condition of the direction indicators, and to operate as a function of the signal the vibrating motors associated to the flat bases arranged on a same side as an active direction indicator. A plurality of pressure sensors connected to the electronic unit is provided at a perimeter of the support base, each one configured to transmit a signal indicating presence or not of weight of a driver on a corresponding position of the seat cover.

### CROSS-REFERENCE TO RELATED APPLICATIONS

This application is a continuation of U.S. patent application Ser. No. 18/284,521, with a 371(c) date of Sep. 27, 2023, which is a national stage entry of PCT/IB2022/052740, with an international filing date of Mar. 25, 2022, which claims the priority benefit of Italian Patent Application No. 102021000008390, with a filing date of Apr. 2, 2021; each of these priority applications is hereby incorporated by reference in its entirety.

### FIELD OF THE INVENTION

The present invention relates to the technical field comprising devices used in the automotive vehicle field to warn the driver about their functioning condition to make driving safer.

In particular, the present invention relates to a car seat cover device provided with vibrating warning system for signaling direction indicators. The present invention aims at developing a control system of the direction indicator operating to be coupled with the classic warning light and the classic sound indicating that the direction indicator is on.

### BACKGROUND OF THE INVENTION

The direction indicator, commonly known as indicator or direction indicator lamp, is a terminal of the signaling device, a vehicle is provided with, whose main function is to signal to others preventively that the driving direction of the vehicle is changing.

The technical problem arises from the fact that the driver very often forgets that the direction indicator is on, thus compromising the vehicle driving safety since he indicates a direction change that is not really going to happen. This situation can clearly lead to an accident, since by wrongly interpreting a vehicle direction change, which is not going to happen instead, the other vehicles can carry out maneuvers with the risk of a collision with the vehicle indicating the wrong direction change.

To prevent that a driver forgets to turn off the direction indicator, he is warned by a warning light which often indicates also the side indicated by the indicator. Always aiming at preventing forgetting, a sound is coupled with the warning light when the direction indicator is turned on.

Two technical problems arise: the first one relates to the fact that looking at a warning light causes the driver to take his eyes off the road. This situation is clearly to be avoided since it distracts inevitably the driver, thus comprising the driving safety.

To such aim the acoustic warning can be relied on, which is turned on with the indicator. But unlike the warning light, such acoustic warning does not indicate the direction of the indicator turned on, and so it provides less information. So, to see the side the indicator is indicating the driver has inevitably to look at the warning light provided on the dashboard of the car, thus taking his eyes off the road. Moreover, if the driver while driving turns on music or the environmental noise is loud, there is yet the risk not to hear the signal of the direction indicator turned on. So, there persists the technical problem to warn the driver safely when the direction indicator is on.

At the state of the art, seat covers are known which are provided with vibrating warning systems connected to electronic control means which warn the driver about the turning on condition of the direction indicators. Devices of this type are described for example in EP 3439912 and US2008/128190.

Anyway, the devices described in such documents are not correctly adapted to the various drivers, who can have different body builds, and as a function of their own driving habits, can sit assuming various positions on the seat.

### SUMMARY OF THE INVENTION

One aim of the present invention is to provide a car seat cover which overcomes the limits linked to the embodiments known at the state of the art.

The aim of warning the driver, without distracting him, about the direction indicator operating and about its relative side is reached by means of a device comprising the characteristics described in the main claim.

The dependent claims describe advantageous embodiments of the invention.

According to a first aim, the present invention provides a device configured to warn the driver that a direction indicator is on, without distracting him from driving.

According to another aim, the present invention provides a device configured to warn the driver about which of the direction indicators is turned on, whether the right one or the left one.

According to another aim, the present invention provides said warning system of the direction indicator turned on to be integrated in the car. According to another aim, the present invention provides a device, which in addition to providing an indication about the condition of the direction indicator, provides a functioning mode which by means of vibration can provide a massage to the driver thus making driving safer and more comfortable.

### BRIEF DESCRIPTION OF THE FIGURES

The device will be now described with reference to the appended figures:

FIG. 1 shows a top view of the invention with all its essential elements;

FIG. 2 shows a top view of the invention mounted on the seat (7) of a car.

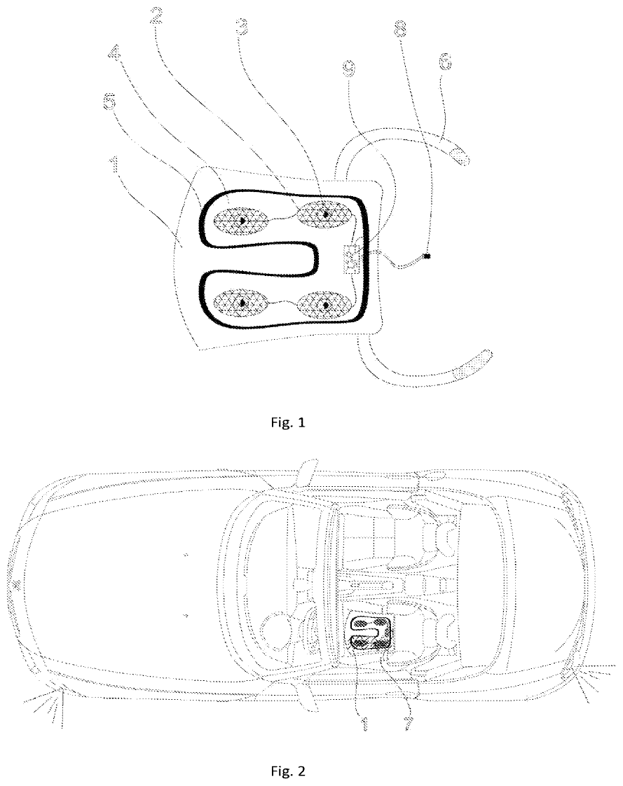

### DETAILED DESCRIPTION

The present invention realizes the prefixed aims since it is a car seat cover device provided with vibrating warning system for signaling the direction indicators, comprising:
a cover seat (1), which can be fixed by means of elastic bands (6) to the seat (7) of a car;
a U-shaped support base (4), integral with the upper surface of said seat cover (1), with the U-shaped base arranged at the position of the driver's rachis;
a plurality of flat bases (2), arranged on the right side and left side of the support base (4), each one of said flat bases (2) being provided with at least a vibrating motor (3), electrically connected to an electronic control unit (9);
an electronic control unit (9) provided with a connector (8) allowing its connection to the car electric system and configured to be connected by means of the connector (8) to the vehicle control gearcase to receive by the vehicle gearcase the signal relating to the condition of the direction indicators of said car and to operate as a function of said signal the vibrating motors (3) arranged on the right side if the direction indicator relating to the right side is on, the vibrating motors (3) arranged on the left side if the direction indicator relating to the left side is on, thus generating vibrations which are perceived by the driver sitting on the seat cover (1).

The electronic control unit (9) is also configured to turn off the vibrating motors when the direction indicator is turned off.

The vibrating motors (3) can be for example of eccentric mass type, and in another embodiment of the invention they can be integrated directly in the car seat.

A particular aspect of the present invention is that in order to operate only the vibrating motors (3) needed to warn the driver and to leave turned off the ones the driver is not sitting on, a plurality of pressure sensors (5) is provided on the upper surface of the support base (4), which pressure sensors are arranged on the U-shaped perimeter of said support base (4) and are connected to the electronic control unit (9).

Each one of the pressure sensors (5) is configured to transmit to the electronic control unit (9) a signal indicating the presence or not of the driver weight on the corresponding position of the seat cover.

The control unit (9) is configured to receive the signals sent by said pressure sensors, to associate to each signal the position of the respective pressure sensor (5) and to activate, in case of activation of a direction indicator, only the vibrating motors (3) arranged at the respective pressure sensor.

Conveniently, the position of each pressure sensor (5) and the identification of the vibrating motors (3) arranged at each sensor are data stored in the electronic gearcase (9).

Preferably, the electronic control unit (9), by knowing the position of said pressure sensors (5) along the perimeter of said support base (4), will activate only the vibrating motors (3) arranged at a distance lower than 5 cm to the areas corresponding to the pressure sensors (5) which detect the pressure due to the driver, leaving turned off the vibrating motors (3) arranged at greater distances. Thanks to this measure, the system adapts oneself to the dimension and to the way the driver is sitting, and the vibration is distributed to the right side and left side only where it is needed.

Moreover, to improve the driving comfort, the support base (4) can be arranged on the lumbar support.

The U-shaped support base (4) can be coated outside with female Velcro and the plurality of flat bases (2) can be provided with a lower surface made by male Velcro which fixes the female Velcro to the base support (4), thus making said flat bases (2) repositionable on said support base (4). In this way, it is possible to adjust the position of the vibrating motors (3) according to the anthropometrical dimensions of the usual driver.

The electronic control unit (9) can activate the vibrating motors (3) also in a functioning mode of massaging type, thus providing useful information, but at the same time increasing the vehicle driving comfort. A seat heating system can be coupled to the massage by introducing for example electric resistances integrated in the flat bases (2).

Since the electronic control unit (9) is connected to the vehicle electronic gearcase, it can activate the vibrating motors (3) to signal other alarm information of the vehicle, which can be distinguished by the driver by intensity, position of the vibration and vibrational frequency.

I claim:

1. A device provided with a vibrating warning system for signaling a condition of at least one indicator, comprising:
a support structure suitable for being associated with a vehicle seat;
at least one vibrating motor arranged on said support structure, said at least one vibrating motor being electrically connected to an electronic control unit; and
an electronic control unit provided with a connector allowing connection of the electronic control unit to a vehicle control unit, the electronic control unit being configured to receive by the vehicle control unit a signal relating to the condition of the at least one indicator, to operate as a function of said signal the at least one vibrating motor, thus generating vibrations perceivable by a user occupying the vehicle seat, wherein
at a perimeter of said support structure a plurality of pressure sensors is provided, which are connected to said electronic control unit and each one configured to transmit to said electronic control unit a signal indicating presence or not of weight of the driver on a corresponding position of the support structure, and wherein
said electronic control unit is configured to receive the signals sent by said pressure sensors, to associate to each signal a position of a respective pressure sensor and to activate, in case of activation of at least one indicator, only the vibrating motor positioned at least at a pressure sensor detecting the presence of weight of the driver on the corresponding position of the support structure.

2. The device of claim 1, wherein said support structure can be arranged on a lumbar support.

3. The device of claim 1, wherein said electronic control unit is configured to activate the at least one vibrating motor in a massaging type functioning mode.

4. The device of claim 1, wherein said support structure is a vehicle seat cover.

5. The device of claim 1, wherein said support structure is integral to the vehicle seat.

6. The device of claim 4, wherein the vehicle seat cover is fixable by elastic bands to the vehicle seat.

7. The device of claim 1, wherein the vehicle is a car.

8. The device of claim 1, wherein said at least one indicator is a direction indicator.

9. The device of claim 8, further comprising:
a plurality of flat bases arranged on right and left sides of said support structure, each one of said flat bases being provided with at least one vibrating motor;
the electronic control unit being configured to receive by the vehicle control unit a signal relating to the condition of the at least one direction indicator, to operate as a function of said signal the at least one vibrating motor associated to the flat bases arranged on a same side as an active direction indicator;
said control unit is configured to activate, in case of activation of at least one direction indicator, only the vibrating motors associated to the flat bases arranged at the same side as the active direction indicator.

10. The device of claim 9, wherein said support structure is a U-shaped support structure and, when associated with a vehicle seat, the U-shaped support structure is arranged with a base of the U at the position of the driver's rachis.

11. The device of claim 10, wherein said U-shaped support structure is coated outside with female Velcro, and wherein said at least one vibrating motor is housed in flat bases coated on a lower side with male Velcro, thus making said flat bases on said U-shaped support structure.

12. The device of claim 1, wherein the condition of at least one indicator is an alarm information of a vehicle.

13. The device of claim 12, wherein the alarm information of a vehicle can be distinguished by the user by intensity, position of vibration and vibrational frequency of the at least one vibrating motor.

14. The device of claim 1, wherein the condition of at least one indicator is an alarm information from a source external to a vehicle.

15. The device of claim 14, wherein the source external to the vehicle is a smartphone.
